(19) United States
(12) Patent Application Publication
(10) Pub. No.: US 2006/0059736 A1
(43) Pub. Date: Mar. 23, 2006

(54) Bottle poetry label

(76) Inventors: Zohreh Moody, Arroyo Grande, CA (US); Akbar Moarefy, Arroyo Grande, CA (US)

Correspondence Address: ZOHREH MOODY AND AKBAR MOAREFY, 432 RODEO DRIVE, ARROYO GRANDE, CA, 93420, US

(21) Appl. No.: 10/936,067

(22) Filed: Sep. 9, 2004

(51) Int. Cl. G09F 3/00

(52) U.S. Cl. 40/310

(57) ABSTRACT

Our invention provides poetry label on bottles of beverages such as wine, Champaign and water. Poetry may be printed on the main beverage identifier label or it may be printed on a secondary label affixed to the bottle above, below or behind the main beverage identifier label. Another variation of this invention is a poetry tag connected to the bottle through a link such as string or ribbon. This invention is neither limited to the manner by which the label is attached to the bottle nor it is limited to the material selection for the label, tag or link.

### CROSS REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

This invention relates to bottle labels, and more particularly to the use of poetry label on the bottles of beverages such as wine Champaign and water.

### SUMMARY OF THE INVENTION

This invention generally relates to the bottle labels for beverages such as wine, Champaign and water. In one embodiment the poetry labels is affixed on the surface of the bottle. In another embodiment, poetry label is in the form of a tag attached to the bottle through a link such as string or ribbon. This invention is intended as a marketing tool for poetry lovers and general public who may find poetry label on a beverage bottle as an added value. In a social setting, poetry label on a bottle of wine Champaign and other beverages will serve as a conversation starter. Poetry labels may also serve to celebrate poets and educate the public about their work.

### BRIEF DESCRIPTION OF THE SEVERAL VIEWS OF THE DRAWING

FIG. (1) shows poetry label as a part of the primary wine label.

FIG. (2) shows a poetry label as a secondary wine label affixed to the bottle above the primary wine label.

FIG. (3) shows a removable wine poetry label.

FIG. (4) shows a wine poetry tag attached to a wine bottle by a string.

### DETAIL DESCRIPTION OF THE INVENTION

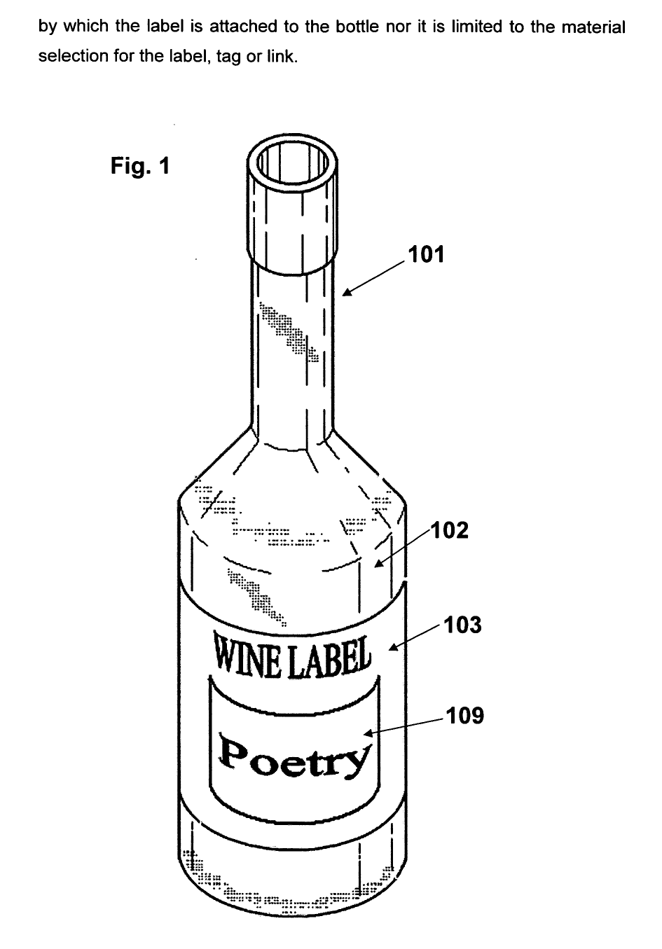

FIG. 1 is a perspective view of the present invention product bottle poetry label system. The system 101 is a bottle of wine having an exterior surface 102. For the purpose of simplicity the wine or beverage bottle will be described hereafter as bottle. A primary bottle label 103 having an interior surface (not shown), is affixed to the exterior surface 102 of the bottle 101. A primary bottle label 103 has an exterior surface with markings identifying the product such as product type, vintage, type of grape, growing region, awards, price, barcode, reviews and/or distributor. A region 109 is provided on the primary bottle label 103 on which poetry is printed. In this case the poetry label is an integral part of the primary product label. This invention is not limited to the background color or graphics used on the bottle label 103. This invention is not limited to any particular method that the primary bottle label 103 is affixed or printed on the surface of the bottle 102.

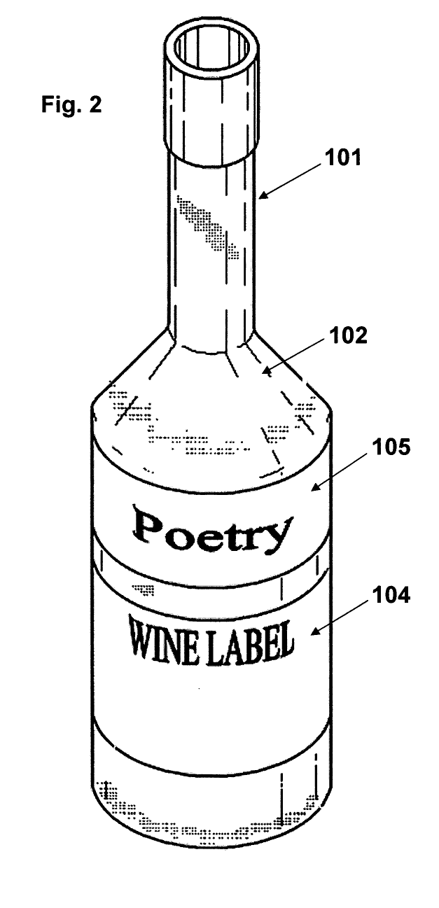

FIG. 2 is a perspective view of the present invention product bottle poetry label system implemented as a secondary label 105. The poetry label as a secondary label 105 has an exterior surface on which poetry is printed. The poetry label as a secondary label 105 may be affixed to the surface of the bottle 102 above or below (not shown) the primary label 104. A primary bottle label 104 has an exterior surface with markings identifying the product such as product type, vintage, type of grape, growing region, awards, price, barcode, reviews and/or distributor. This invention is not limited to any particular method that the bottle poetry label 105 is affixed or printed on the surface of the bottle 102.

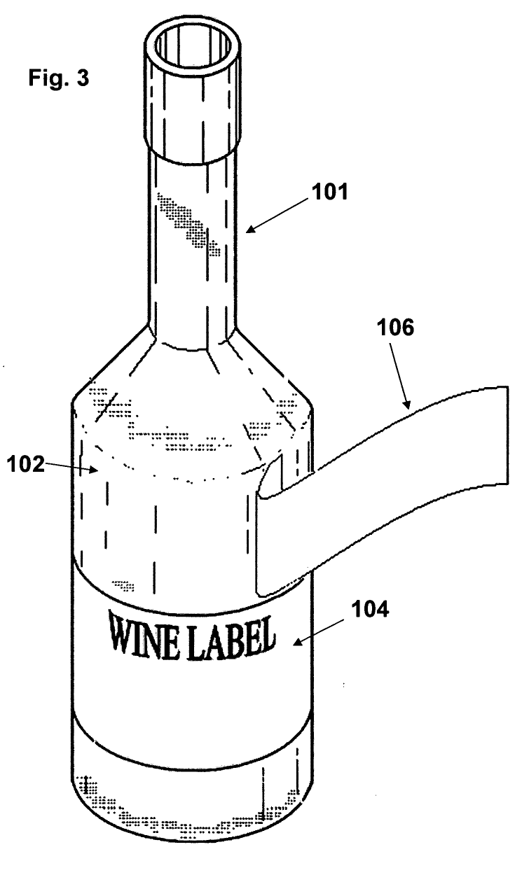

FIG. 3 is a perspective view of the present invention product bottle poetry label system implemented on a removable label 106. The removable poetry label 106 has an exterior surface on which poetry is printed. In some variations the removable label 106 is only designed with poetry text. In other variations, other texts or graphics are also printed on the removable label 106. The removable label 106 may be affixed to the surface of the bottle 102 above (FIG. 3) or below (not shown) the primary label 104. A primary bottle label 104 has an exterior surface with markings identifying the product such as product type, vintage, type of grape, growing region, awards, price, barcode, reviews and/or distributor. This invention is not limited to any particular method that the removable bottle poetry label 106 is affixed on the surface of the bottle 102.

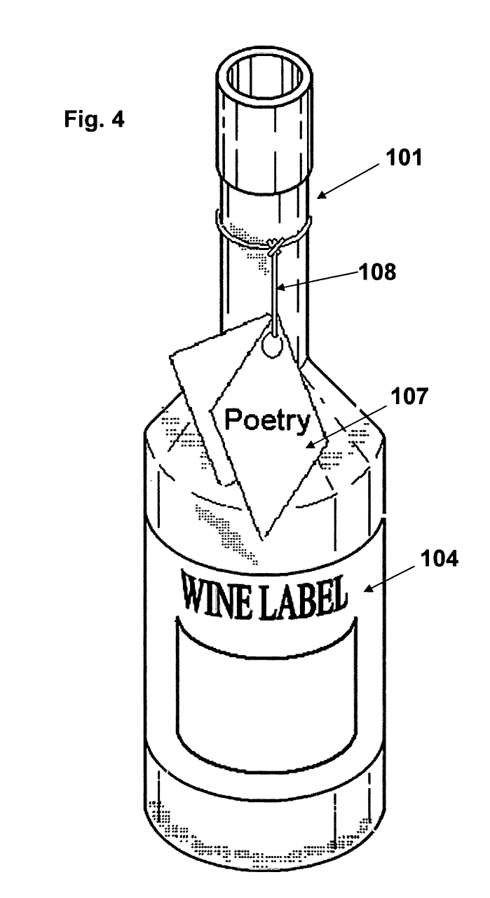

FIG. 4 is a perspective view featuring the present invention product bottle poetry tag variation. Poetry is printed on any or both surfaces of the poetry tag 107. As seen in FIG. 4, a link 108 has a first end attached to the tag 107 and a second end attached to the bottle 101. The link 108 may be attached to the bottle neck (shown in FIG. 4) or any other part of the bottle 101 (not shown). The material of poetry tag variation 107 may be thin, such as paper, or semi-rigid and made from materials such as thick paper, cardboard or plastic. The poetry tag 107 may be also made from any rigid material such as metal, composites, or hard plastics. The link 108 can be a string of any conventional or non-conventional material such as hemp, fiber, ribbon, cloth like material or even paper. The invention is not limited to any specific link material.

We claim:

1. A bottle poetry label system comprising: a bottle having an exterior surface; a label having an interior surface affixed to the exterior surface of the bottle and poetry printed on the surface of the label affixed on the surface of the bottle.

2. The system of claim 1 where the poetry label is an integral part of the main product identifier label and poetry is printed on the surface the main product identifier label.

3. The system of claim 1 where the poetry label is a secondary label and it is affixed to the bottle above, below or behind the main product identifier label.

4. A bottle poetry detachable tag system comprising a bottle having an exterior surface; a poetry tag with pre-printed poetry on its surface, a link selected from the group including string, ribbon and elastic having a first end attached to the tag and a second end attached to the bottle surface.
